(19) United States
(12) Patent Application Publication
(10) Pub. No.: US 2011/0193798 A1
(43) Pub. Date: Aug. 11, 2011

(54) APPARATUS FOR TOUCH SENSING, DISPLAY DEVICE, AND OPERATING METHOD FOR THE SAME

(75) Inventors: Zhi Feng Zhan, Yongin-city (KR); Jong Woong Park, Yongin-city (KR); Hee-Chul Hwang, Yongin-city (KR); Gaun-Young Jeong, Yongin-city (KR); Byung-Ki Chun, Yongin-city (KR)

(73) Assignee: Samsung Mobile Display Co., Ltd., Yongin-city (KR)

(21) Appl. No.: 12/945,966

(22) Filed: Nov. 15, 2010

(30) Foreign Application Priority Data
Feb. 11, 2010 (KR) 10-2010-0012887

(51) Int. Cl. G06F 3/041

(52) U.S. Cl. 345/173

(57) ABSTRACT

A touch sensing apparatus includes: a sense unit connected to a sense scan line and a sense line; a location detection unit that detects a location of a touch from a sense signal transmitted from the sense unit through the sense line; and a determination and trigger unit that determines whether a touch is sensed from the sense signal, generates a trigger signal that instructs whether or not to operate the location detection unit, and transmits the trigger signal to the location detection unit. The determination and trigger unit includes a logic operation circuit that generates a trigger signal for operation of the location detection unit when the sense signal implies that a touch is sensed while a sense driving signal is applied to at least one of a plurality of sense scan lines. The location detection unit is operated at a minimum to minimize power consumption.

### CROSS-REFERENCE TO RELATED APPLICATION

This application claims the benefit of Korean Patent Application No. 10-2010-0012887, filed Feb. 11, 2010 in the Korean Intellectual Property Office, the disclosure of which is incorporated herein by reference.

### BACKGROUND

1. Field

Aspects of the present invention relate to a touch sensing apparatus, a display device including the same, and a driving method thereof. More particularly, aspects of the present invention relate to a touch sensing apparatus having an advantage of reducing power consumption for touch information extraction, and a display device including the same and a driving method for the same.

2. Description of the Related Art

As a representative display device, a liquid crystal display (LCD) includes two display panels provided with pixel electrodes and a common electrode, and a liquid crystal layer having dielectric anisotropy interposed between the two panels. The pixel electrodes are arranged in a matrix format and are connected to a switch (such as a thin film transistor (TFT)) to sequentially receive a data voltage by row. The common electrode is formed over the entire surface of the display panel to receive a common voltage. The pixel electrodes, the common electrode, and the liquid crystal layer interposed between the pixel electrodes and the common electrode form a liquid crystal capacitor from a circuital view. The liquid crystal capacitor and a switch connected thereto become a basic unit forming a pixel.

In the liquid crystal display (LCD), an electric field is generated in the liquid crystal layer by applying voltages to the two electrodes. Transmittance of light passing through the liquid crystal layer is controlled by controlling the electric field to thereby display a desired image.

A touch screen panel is an apparatus that executes a desired command to a device (such as a computer) by writing or drawing on the screen with a finger or a touch pen (e.g., stylus), or executing an icon. An LCD provided with the touch screen panel can determine whether a user's finger or a touch pen contacts the screen and information on a touched location. However, the touch screen panel increases cost. Further, an additional process for attaching the touch screen panel to the liquid display panel causes a yield decrease, luminance deterioration of the liquid crystal display panel, and increase in thickness of the product.

A technique for installing a sensing element in an LCD has been developed for solving the above-stated problems. The sensing element senses a change in light or pressure applied to the screen by a user's finger so that the LCD can determine whether the user's finger has touched the screen and information on location of the touch. For reading a sense data signal from the sensing element and extracting touch information, a large amount of power is consumed. Power consumption of a mobile LCD (such as a mobile phone or a personal digital assistant (PAD)) should be reduced for long-time portability and mobility.

The above information disclosed in this Background section is only for enhancement of understanding of the background of the invention and therefore it may contain information that does not form the prior art that is already known in this country to a person of ordinary skill in the art.

### SUMMARY

Aspects of the present invention provide a touch sensing apparatus that can reduce power consumption for touch information extraction, a display device including the same, and a driving method for the same.

A touch sensing apparatus according to an exemplary embodiment of the present invention includes: sense unit connected to a sense scan line and a sense line; a location detection unit that detects a location of a touch from a sense signal transmitted from the sense unit through the sense line; and a determination and trigger unit that determines whether a touch is sensed from the sense signal transmitted from the sense unit, generates a trigger signal that instructs whether or not the location detection unit is to operate, and transmits the trigger signal to the location detection unit. The determination and trigger unit includes a logic operation circuit for generating the trigger signal, and the logic operation circuit generates a trigger signal for operation of the location detection unit when the sense signal implies that touch is sensed while a sense driving signal is applied to at least one of a plurality of sense scan lines.

According to an aspect of the invention, the logic operation circuit may generate a trigger signal that stops operation of the location detection unit when the sense signal implies that touch is not sensed while the sense driving signal is applied to at least one of the plurality of sense scan lines.

According to an aspect of the invention, the determination and trigger unit may determine the sense signal that implies touch is sensed to be “0” and the sense signal that implies touch is not sensed to be “1”.

According to an aspect of the invention, the sense unit may include: a reference capacitor having a first end connected to the sense scan line and a second end connected to the sense line; a variable capacitor having a first end connected to the sense line and a second end connected to a common electrode; and a liquid crystal layer between the first and second ends of the variable capacitor. The sense unit may include a sense unit that senses touch in a row direction or senses touch in a column direction.

According to an aspect of the invention, the logic operation circuit may be a NAND circuit.

According to an aspect of the invention, the touch sensing apparatus may further include switches respectively connected to the plurality of sense scan lines to apply predetermined voltages thereto.

According to an aspect of the invention, the touch sensing apparatus may further include a sense driver that applies the sense driving signal of a gate-on voltage for turning on the switches and a gate-off voltage for turning off the switches to gate electrodes of the switches.

According to an aspect of the invention, the touch sensing apparatus may further include an amplification unit connected to the sense line to amplify and filter the sense signal.

According to an aspect of the invention, the touch sensing apparatus may further include a latch unit for extracting and maintaining a sample of the sense signal.

A display device according to another exemplary embodiment of the present invention includes: a display panel having a plurality of pixels that display an image and a plurality of sense units that generate a sense signal, the plurality of pixels and the plurality sense units arranged in a matrix format; a location detection unit that detects a location of a touch from the sense signal; and a determination and trigger unit that determines whether touch is sensed from the sense signal, generates a trigger signal to instruct whether or not to operate the location detection unit, and transmits the trigger signal to the location detection unit. The determination and trigger unit generates a trigger signal for operation of the location detection unit when at least one sense signal transmitted to one row-direction sense unit or one column-directional sense unit implies that touch is sensed.

According to an aspect of the invention, the determination and trigger unit may include a NAND circuit for generating the trigger signal, and determines a sense signal implying that touch is sensed to be “0” and a sense signal implying that touch is not sensed to be “1”.

According to an aspect of the invention, the display device may further include a plurality of switches respectively connected to a plurality of sense scan lines that are connected to the plurality of sense units and transmit predetermined voltages.

According to an aspect of the invention, the display device may further include a sense driver that applies a sense driving signal including a gate-on voltage that turns on the switches and a gate-off voltage that turns off the switches to gate electrodes of the switches.

According to an aspect of the invention, the display device may further include an amplification unit that amplifies and filters the sense signal.

According to an aspect of the invention, the display device may further include a latch unit that extracts and maintains a sample of the sense signal.

A driving method according to another exemplary embodiment of the present invention is provided to a display device including a display panel having a plurality of pixels displaying an image and a plurality of sense units generating a sense signal, the pixels and the sense units arranged in a matrix format, a location detection unit determining a location of touch from the sense signal, and a determination and trigger unit instructing whether or not to operate the location detection unit.

According to an aspect of the invention, the driving method includes: generating a sense signal by applying a predetermined voltage to one row-direction sense unit or one column-directional sense unit among the plurality of sense units; generating a first trigger signal that instructs the location detection unit to operate when at least one sense signal implies that touch is sensed; and determining a location of a touch from the sense signal according to the first trigger signal.

According to an aspect of the invention the driving method may further include generating a second trigger signal instructing the location detection unit to stop operation when all the sense signals imply that touch is not sensed, and ignoring the sense signal according to the second trigger signal.

According to an aspect of the invention, the driving method may further include amplifying and filtering the generated sense signal.

According to an aspect of the invention, the driving method may further include comprising extracting and maintaining a sample of the amplified sense signal.

According to the present invention, power consumption for touch information extraction can be reduced by operating a location detection unit that uses a large amount of power for touch information extraction with minimum power.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram of an LCD illustrated from the view of a pixel according to an exemplary embodiment of the present invention.

FIG. 2 is an equivalent circuit diagram of a pixel of the LCD of FIG. 1.

FIG. 3 is a block diagram of a sense unit for row directional contact of the LCD of FIG. 1.

FIG. 4 is a block diagram of a sense unit for column directional contact of the LCD of FIG. 1.

FIG. 5 is an equivalent circuit diagram of a sense unit according to the exemplary embodiment of the present invention.

FIG. 6 is a block diagram of a contact sense unit of the LCD according to the exemplary embodiment of the present invention.

FIG. 7 is a block diagram of a NAND circuit of a determination and trigger unit according to the exemplary embodiment of the present invention.

### DETAILED DESCRIPTION

Reference will now be made in detail to the present embodiments of the present invention, examples of which are illustrated in the accompanying drawings, wherein like reference numerals refer to the like elements throughout. The embodiments are described below in order to explain the present invention by referring to the figures.

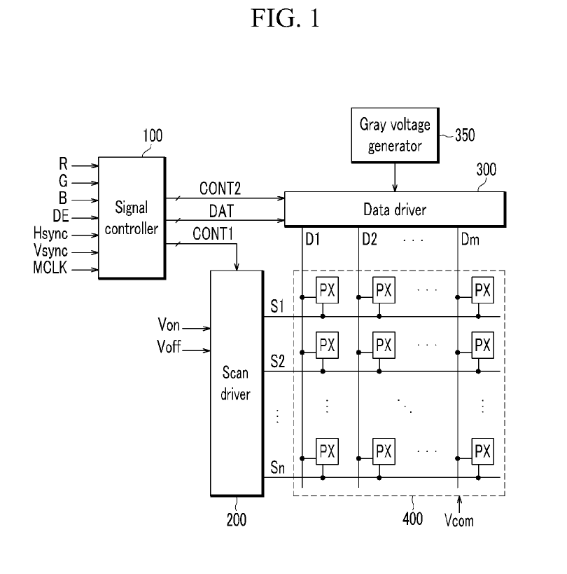

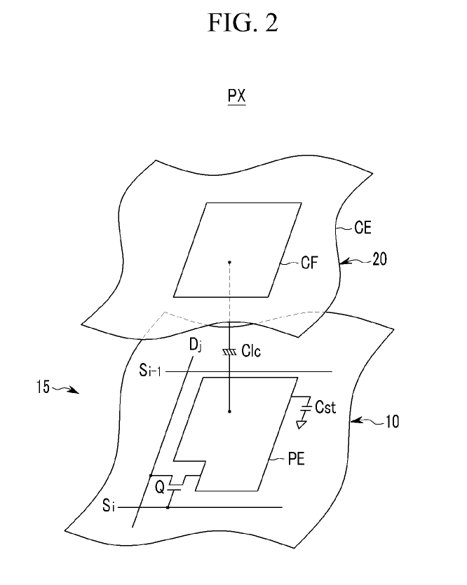

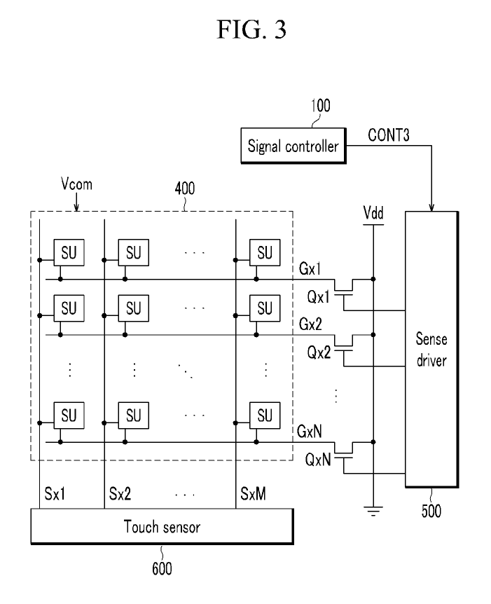

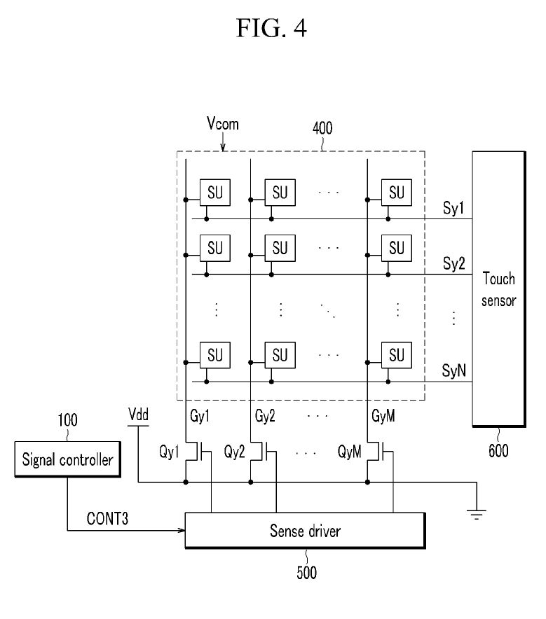

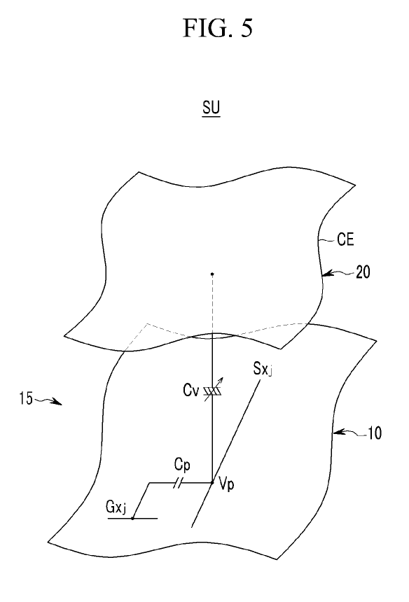

FIG. 1 is a block diagram of an LCD illustrated from the view of a pixel according to an exemplary embodiment of the present invention. FIG. 2 is an equivalent circuit diagram of a pixel of the LCD of FIG. 1. FIG. 3 is a block diagram of a sense unit for row directional contact of the LCD of FIG. 1. FIG. 4 is a block diagram of a sense unit for column directional contact of the LCD of FIG. 1. FIG. 5 is an equivalent circuit diagram of a sense unit according to the exemplary embodiment of the present invention.

Referring to FIG. 1, FIG. 3, and FIG. 4, a liquid crystal display (LCD) includes a liquid crystal panel assembly 400, a scan driver 200 connected to the liquid crystal panel assembly 400, a data driver 300, a sense driver 500, a touch sensor 600, a gray voltage generator 350 connected to the data driver 300, and a signal controller 100 controlling the respective drivers 200, 300, and 500. While not required in all aspects, the signal controller 100 can be implemented using one or more processors executing software and/or firmware encoded on a computer readable medium.

Referring to FIG. 1 to FIG. 5, the liquid crystal display panel assembly 400 includes a plurality of pixels PX respectively connected to a plurality of display signal lines S1-Sn and D1-Dm and arranged in a matrix format. In addition, the liquid crystal display panel assembly 400 includes a plurality of sense units SU respectively connected to a plurality of sense signal lines Gx1-GxN and Sx1-SxM, or Gy1-GyM and Sy1-SyN, and arranged in a matrix format. In view of the sense units SU, the embodiments shown in FIG. 3 and FIG. 4 may be adopted.

Referring to FIG. 2 and FIG. 5, the liquid crystal display panel assembly 400 includes a thin film transistor display panel 10, a common electrode display panel 20, and a liquid crystal layer 15 interposed therebetween.

The plurality of display signal lines S1-Sn and D1-Dm include a plurality of scan lines S1-Sn transmitting scan signals and a plurality of data lines D1-Dm transmitting data signals. A plurality of detection signal lines Gx1-GxN and Sx1-SxM, or Gy1-GyM and Sy1-SyN, include a plurality of row detection scan lines Gx1-GxN transmitting row scan signals for row direction contact detection and a plurality of row detection lines Sx1-SxM transmitting row detection signals, or a plurality of column detection scan lines Gy1-GyM transmitting column scan signals for column direction contact detection and a plurality of column detection lines Sy1-SyN transmitting column detection signals.

With respect to the embodiments in FIGS. 1 and 3, the plurality of scan lines S1-Sn and the plurality of row detection scan lines Gx1-GxN substantially extend in a row direction and are almost parallel with each other. The plurality of data lines D1-Dm and the plurality of row detection lines Sx1-SxM substantially extend in a column direction and are almost parallel with each other.

With respect to the embodiments shown in FIGS. 1 and 4, the plurality of scan lines S1-Sn and the plurality of column detection lines Sy1-SyN substantially extend in a row direction and are almost parallel with each other. The plurality of data lines D1-Dm and the plurality of column scan lines Gy1-GyM substantially extend in a column direction and are almost parallel with each other.

In FIG. 3, each of the row detection scan lines Gx1-GxN is applied with a predetermined Vdd voltage. Row switches Qx1-QxN are provided between the respective row detection scan lines Gx1-GxN and the Vdd voltage. The row switches Qx1-QxN respectively include first ends connected to the row scan lines Gx1-GxN, second ends connected to the Vdd voltage, and gate electrodes connected to the sense driver 500.

In FIG. 4, the column detection scan lines Gy1-GyM are applied with a predetermined Vdd voltage. Column switches Qy1-QyM are provided between the respective column detection scan lines Gy1-GyM and the Vdd voltage. The column switches Qy1-QyM respectively include first ends connected to the column detection scan lines Gy1-GyM, second ends connected to the Vdd voltage, and gate electrodes connected to the sense driver 500.

The scan lines S1-Sn are connected to the scan driver 200. The plurality of data lines D1-Dm are connected to the data driver 300. The sense driver 500 is connected with the gate electrodes of the plurality of row switches Qx1-QxN, and the touch sensor 600 is connected with the plurality of row detection lines Sx1-SxM in the embodiment shown in FIG. 3. The sense driver 500 is connected with the gate electrodes of the plurality of column switches Qy1-QyM, and the touch sensor 600 is connected with the plurality of column contact lines Sy1 to SyN in the embodiment shown in FIG. 4.

Referring to FIG. 2, each pixel PX includes a switch Q connected to the display signal lines S1-Sn and D1-Dm, a liquid crystal capacitor Clc, and a storage capacitor Cst. The liquid crystal capacitor Clc and the storage capacitor Cst are connected to the switch Q. The storage capacitor Cst may be omitted as necessary.

The shown switch Q is a three-terminal element such as a thin film transistor provided to the thin film transistor display panel 10. The switch Q includes a gate terminal connected to the scan lines S1 to Sn, an input terminal connected to the data lines D1 to Dm, and an output terminal connected to the liquid crystal capacitor Clc and the storage capacitor Cst. The thin film transistor includes amorphous silicon or polycrystalline silicon.

A pixel electrode PE of the thin film transistor display panel 10 and the common electrode CE of the common electrode display panel 20 are used as terminals of the liquid crystal capacitor Clc. The liquid crystal layer 15 between the pixel electrode PE and the common electrode CE functions as a dielectric material. The pixel electrode PE is connected to the switch Q. The common electrode CE is formed at the front of the common electrode display panel 20 and applied with the common voltage Vcom shown in FIG. 2. Unlike as shown in FIG. 2, the common electrode CE may be provided in the thin film transistor display panel 10. In this case, at least one of the two electrodes PE and CE may have a linear or bar shape.

The storage capacitor Cst that assists the liquid crystal capacitor Clc is formed with separate signal lines (not shown) in the thin film transistor display panel 10 and the pixel electrode PE that overlap each other, interposing an insulating material therebetween. A predetermined voltage (such as the common voltage Vcom) is applied to the separate signal lines.

In order to represent colors, each pixel PX displays one of primary colors (i.e., spatial division) or each pixel PX displays primary colors according to time (i.e., time division) so that a desired color can be expressed by the spatial or temporal sum of the primary colors. The primary colors may be three primary colors of red, green, and blue, but the invention is not limited thereto. As an example of spatial division, FIG. 2 illustrates that each pixel PX is provided with a color filter CF that expresses one of the primary colors in an area of the common electrode display panel 20, corresponding to the pixel electrode PE. Unlike as shown in FIG. 2, the color filter CF may be formed above or below the pixel electrode PE of the thin film transistor display panel 10. At least one polarizer (not shown) that polarizes light may be provided at the external side of the liquid crystal display panel assembly 400.

Referring to FIG. 5, the sense unit SU is connected to the column sense scan lines Gx1-GxN and the sense lines Sx1-SxM. A variable capacitor Cv is connected to the column sense line Sxj. A reference capacitor Cp connected between the column sense line Sxj and the column sense scan line Gxi (1<=i<=N, 1<=j<=M). The reference capacitor Cp includes a first end connected to the column sense scan line Gxi that is applied with a predetermined Vdd voltage, and a second end connected to the column sense line Sxj of the thin film transistor display panel 10.

The variable capacitor Cv includes a first end connected to the column sense line Sxj of the thin film transistor display panel 10 and a second end connected to the common electrode CE. The liquid crystal layer 15 between the two terminals functions as a dielectric material. Capacitance of the variable capacitor Cv varies according to an external factor such as a user's touch applied to the liquid crystal display panel assembly 400. Pressure may be another example of the external factor. When pressure is applied to the common electrode display panel 20, the distance between the two terminals is changed so that the capacitance of the variable capacitor Cv is changed. Once the capacitance of the variable capacitor Cv is changed, a voltage at a node of the reference capacitor Cp and the variable capacitor Cv, depending on the capacitance, is changed. As a column sense signal, the node voltage Vp flows along the column sense line Sxj, and whether or not the user's touch is applied can be determined based thereon.

In FIG. 5, a sense unit SU connected to the column sense scan lines Gy1-GyM and the column sense lines Sy1-SyN is formed by applying the column sense scan lines Gy1-GyM instead of the column sense scan lines Gx1-GxN and the column sense lines Sy1-SyN instead of the row sense lines Sx1-SxM. That is, a sense unit SU that senses column-directional touch has the same structure as of a sense unit SU that senses row-directional touch, and the structure of the sense unit SU sensing the column-directional touch will be omitted.

In the present exemplary embodiment, a mechanism through which the capacitance of the variable capacitor Cv is changed according to the pressure applied to the sense unit SU is used, but the configuration of the sense unit SU of the present invention is not restrictive. For example, the sense unit SU may have a structure in which switches having the sense line of the thin film transistor display panel 10 and the common electrode of the common electrode display panel 20 as two terminals may be physically and electrically connected according to the applied pressure. Alternatively, the sense unit SU may have a structure in which an optical sensor is included and thus an output of the sense signal is controlled with an optical current generated from the optical sensor according to touch.

Operation of the liquid crystal display LCD according to the exemplary embodiment of the present invention will now be described with reference to FIG. 1 to FIG. 5. The signal controller 100 receives video signals R, G, and B input from an external device (such as a computer or a receiver) and input control signals for controlling display of the input video signals. The shown input video signals include video signals R, G, and B include luminance information of each pixel PX, and the luminance has a determined number of grays. For example, the number of grays can be 1024=2¹⁰, 256=2⁸, or 64=2⁶. The input control signals exemplarily include a vertical synchronization signal (Vsync), a horizontal synchronization signal Hsync, a main clock signal MCLK, and a data enable signal DE. However, it is understood that other video signals and/or input signals can be used in addition to or instead of the shown signals.

The signal controller 100 processes the input video signals R, G, and B for operation conditions of the liquid crystal display panel assembly 400 and the data driver 300 based on the input video signals and the input control signals, and generates a scan control signal CONT1 and a data control signal CONT2. The scan control signal CONT1 is provided to the scan driver 200. The data control signal CONT2 and a processed image data signal DAT are provided to the data driver 300. The signal controller 100 provides a sense control signal CONT3 that controls touch sensing to the sense driver 500.

The scan control signal CONT1 includes a scan start signal STV that instructs the start of a scan and at least one clock signal controlling an output of a gate-on voltage Von. The scan control signal CONT1 may further include an output enable signal OE that limits the duration of the gate-on voltage Von.

The data control signal CONT2 includes a horizontal synchronization start signal STH that notifies the transmission start of the image data signal DAT of one pixel row, a load signal LOAD, and a data clock signal HCLK. The load signal LOAD and the data clock signal HCLK are provided for instruction of application of the data signal to the data lines D1-Dm. The data control signal CONT2 may further include a reversal signal RVS that inverts the polarity of a voltage of the data signal with respect to the common voltage Vcom.

The scan driver 200 is connected to the plurality of scan lines S1 to Sn of the liquid crystal display panel assembly 400 to apply a scan signal to the plurality of scan lines S1 to Sn. The scan signal is formed of a combination of the gate-on voltage Von that turns on the switch Q at each Pixel Px, and a gate-off voltage Voff that that turns off the switch Q at each Pixel Px according to the scan control signal CONT1.

The data driver 300 receives the image data signal DAT, and the gray voltage generator 350 selects a gray voltage corresponding to the image data signal DAT. The data driver 300 applies the selected gray voltage to the plurality of data lines D1 to Dm as a data signal. The gray voltage generator 350 may provide a predetermined number of reference gray voltages rather than providing voltages for all the grays, and in this case, the data driver 300 may generate gray voltages for the entire grays by dividing the reference gray voltages and may select a data voltage Vdat corresponding to the data signal.

When the scan driver 200 applies the gate-on voltage Von to the corresponding to one of the scan lines S1 to Sn according to the scan control signal CONT1, the switch Q connected to the one scan line S1 to Sn is turned on and the data signal applied to the plurality of data lines D1 to Dm through the turned-on switch Q is applied to the corresponding pixel PX.

A difference between the data signal applied to the pixel PX and the common voltage Vcom is a charge voltage of the liquid crystal capacitor Clc (i.e., a pixel voltage). Arrangement of liquid crystal molecules varies according to the pixel voltage, and accordingly polarization of light passing through the liquid crystal layer 15 varies. The variation of polarization is represented as a transmittance variation of light by the polarizer provided to the liquid crystal display panel assembly 400, and accordingly a desired image can be displayed.

By repeating such a process using one horizontal period (may be called “1H”, and is the same as a period of a horizontal synchronization signal Hsync and a data enable signal DE) in units, the gate-on voltage Von is sequentially applied to all the scan lines S1-Sn and the data signal is applied to all the pixels PX such that an image of a frame is displayed.

The sense driver 500 sequentially applies a sense driving signal to the gate electrodes of the plurality of row switches Qx1-QxN or the gate electrodes of the plurality of column switches Qy1-QyM. The sense driving signal is formed of a combination of the gate-on voltage Von that turns on the plurality of row switches Qx1-QxN or the plurality of column switches Qy1-QyM, and the gate-off voltage Voff that turns off the plurality of row switches Qx1-QxN or the plurality of column switches Qy1-QyM according to the sense control signal CONT3 issued by the signal controller 100.

The sense driver 500 can turn on the row switches Qx1-QxN by sequentially applying the gate-on voltage Von according to the sense control signal CONT3 issued by the signal controller 100. A predetermined Vdd voltage is applied to a first end of the reference capacitor Cp of each of the sense units SU through the turned-on row switch Qxj. The capacitance of the variable capacitor Cv varies based on existence of a user's touch, and the node voltage Vp between the reference capacitor Cp and the variable capacitor Cv is changed according thereto. The node voltage Vp of each sense unit SU is transmitted to the touch sensor 600 through the respective row sense lines Sx1-SxM. As described, the gate-on voltage Von is sequentially applied to the respective row sense scan lines Gx1-GxN such that the node voltages Vp of all the sense units SU connected thereto are transmitted to the touch sensor 600.

Alternatively, the sense driver 500 may sequentially apply the gate-on voltage Von to the column switches Qy1-QyM according to the sense control signal CONT3, and accordingly a predetermined Vdd voltage is applied to a first end of the reference capacitor Cp of each of the sense units SU through the turned-on column switch Qyi and the node voltage Vp of each of the sense units SU is transmitted to the touch sensor 600 through each of the column sense lines Sy1-SyN. As described, the gate-on voltage is sequentially applied to the respective column sense scan lines Gy1-GyM such that the node voltages Vp of all the sense units SU connected thereto are transmitted to the touch sensor 600.

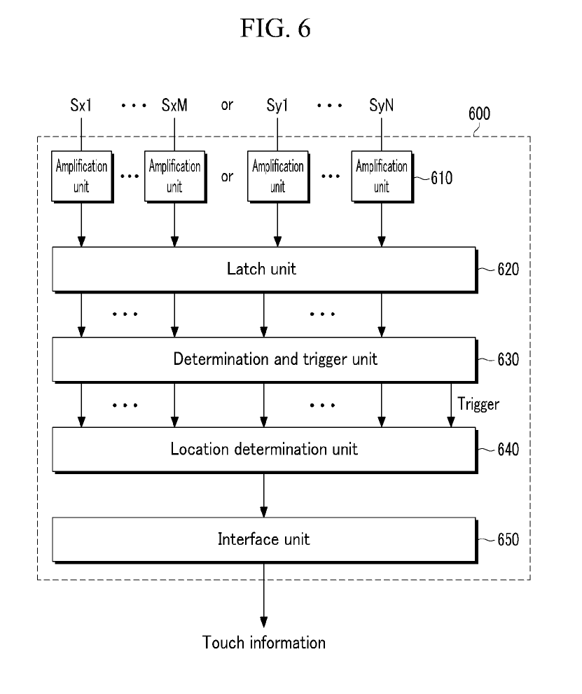

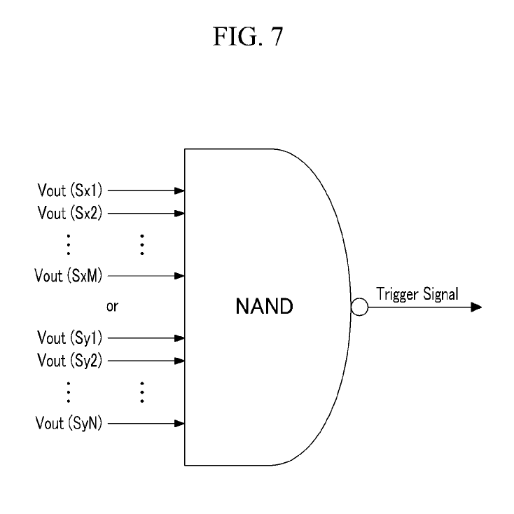

The node voltage Vp of each sense unit SU is a sense signal of the corresponding sense unit SU. The touch sensor 600 detects a user's touch and a location of the touch by reading the sense signal transmitted from the plurality of sense units SU through the plurality of column sense lines Sx1-SxM or the plurality of column sense lines Sy1-SyN. The touch sensor 600 generates a trigger signal according to existence of user's touch from the sense signal transmitted through the plurality of column sense lines Sx1-SxM or the plurality of column sense lines Sy1-SyN by using a NAND circuit, and determines whether to perform touch location detection according to the trigger signal. This will be described in further detail later with reference to FIG. 6 and FIG. 7.

FIG. 6 is a block diagram of the touch sensor 600 of the LCD according to the exemplary embodiment of the present invention. FIG. 7 is a block diagram of the NAND circuit of a determination and trigger unit 630 according to the exemplary embodiment of the present invention. Referring to FIG. 6 and FIG. 7, the touch sensor 600 includes a plurality of amplification units 610, a latch unit 620, the determination and trigger unit 630, a location detection unit 640, and an interface unit 650. While not required in all aspects, elements of the touch sensor 600 can be implemented using one or more processors executing software and/or firmware encoded on a computer readable medium.

The plurality of amplification units 610 are respectively connected to the plurality of row sense lines Sx1-SxM or the plurality of column sense lines Sy1-SyN to amplify and filter the sense signal transmitted through each of the sense lines Sx1-SxM or Sy1-SyN. The latch unit 620 is connected to the plurality of amplification units 610 to receive the sense signal amplified by the amplification unit 610 to thereby extract and maintain samples.

The determination and trigger unit 630 is connected to the latch unit 620, and determines a user's touch from the sense signal transmitted from the latch unit 620 and generates a trigger signal. The determination and trigger unit 630 includes a logic operation circuit for generation of the trigger signal. While not limited there to, the logic operation circuit can be a NAND circuit according to an embodiment of the invention. The trigger signal is a signal for instructing whether or not to operate the location detection unit 640 and is transmitted to the location detection unit 640 together with the sense signal.

While the sense driving signal is sequentially applied to one row sense scan line Gyi or one column sense line Gyi, the NAND circuit generates a trigger signal for stopping operation of the location detection unit 640 if all the sense signals transmitted through the plurality of row sense signals Sx1-SxM or the plurality of column sense signals Sy1-SyN imply that touch is not sensed. In contrast, if one of the sense signals transmitted through the plurality of row sense signals Sx1-SxM or the plurality of column sense signals Sy1-SyN implies that a touch is sensed, and the NAND circuit generates a trigger signal for starting operation of the location detection unit 640.

For example, the determination and trigger unit 630 can determine that a sense signal transmitted through the plurality of row sense signals Sx1-SxM or the plurality of column sense signals Sy1-SyN to be “0” if a touch is not sensed and “1” if a touch is sensed. When the determined sense signal “0” or “1” is input to the NAND circuit, the NAND circuit outputs “0” if all the determined sense signals are “1.” Otherwise, the NAND circuit outputs “1”. The output signal “0” of the NAND circuit is a trigger signal that stops operation of the location detection unit 640, and the output signal “1” is a trigger signal that starts operation of the location detection unit 640.

The location detection unit 640 is connected to the determination and trigger unit 630 to receive the sense signal and the trigger signal transmitted from the determination and trigger unit 630, and to detect a touch location. The trigger signal is generated when a sense driving signal is applied to each of the row sense scan lines Gx1-GxN or each of the column sense scan lines Gy1-GyM and transmitted to the location detection unit 640. The location detection unit 640 detects a touch location from the sense signal of the plurality of sense units SU connected to the corresponding row sense scan line Gx1-GxN or column scan lines Gy1-GyM when the trigger signal that stops operation of the location detection unit 640 is applied. The location detection unit 640 ignores a received sense signal when the trigger signal that stops operation of the location detection unit 640 is applied.

That is, the location detection unit 640 determines a touch location for sense units SU connected to row sense scan lines Gx1-GxN or column sense scan lines Gy1-GyM that are connected to a sense unit SU where a touch is sensed rather that determining a touch location for all the sense units SU. That is, the location detection unit 640 operates only when determination of the touch location is required, and accordingly power consumption for touch location extraction can be minimized.

The location detection unit 640 receives a sense signal transmitted through the plurality of row sense lines Sx1-SxM or the plurality of column sense lines Sy1-SyN for one frame during which the sense driving signal is applied to all the row sense scan lines Gx1-GxN or column sense scan lines Gy1-GyM, and determines row-directional and column-directional touch locations. There may be one of two touch locations within one frame, and the location detection unit 640 can support multi-touch for determining two or more touch locations. The location detection unit 640 transmits information on the touch location to the interface unit 650.

The interface unit 650 transmits the touch information to an external device. A serial peripheral interface may be adopted as the interface unit 650, but the invention is not limited thereto. Moreover, the interface unit 650 need not be used where the touch information is used internally, such as in a personal digital assistant, phone, media player, or computer having an integrated touch screen.

Each of the driving devices 100, 200, 300, 350, 500, and 600 may be directly mounted on the liquid crystal panel assembly 400 in at least one IC chip form, may be mounted on a flexible printed circuit film (not shown) to be attached to the liquid crystal panel assembly 400 in a tape carrier package (TCP) form, or may be mounted on a separate printed circuit board (PCB) (not shown). In addition, each of the units 610, 620, 630, 640, and 650 of the touch sensor 600 may be directly mounted on the liquid crystal panel assembly 400 in at least one IC chip form, may be mounted on a flexible printed circuit film (not shown) to be attached to the liquid crystal panel assembly 400 in a tape carrier package (TCP) form, or may be mounted on a separate printed circuit board (PCB) (not shown).

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A touch sensing apparatus comprising:
a sense unit connected to one of a plurality of sense scan lines and a sense line;
a location detection unit that detects a location of a touch from a sense signal transmitted from the sense unit through the sense line on receipt of a trigger signal indicating that the location detection unit is to operate and does not detect the location on receipt of a trigger signal indicating that the location detection unit is to not operate; and
a determination and trigger unit that determines whether a touch is sensed from the sense signal transmitted from the sense unit, generates the trigger signal that instructs whether or not the location detection unit is to operate, and transmits the trigger signal to the location detection unit,
wherein the determination and trigger unit comprises a logic operation circuit which generates the trigger signal when the sense signal implies that the touch is sensed while a sense driving signal is applied to at least one of the plurality of sense scan lines.

2. The touch sensing apparatus of claim 1, wherein the logic operation circuit generates a trigger signal that stops operation of the location detection unit when the sense signal implies that touch is not sensed while the sense driving signal is applied to the at least one of the plurality of sense scan lines.

3. The touch sensing apparatus of claim 2, wherein the determination and trigger unit determines the sense signal that implies the touch is sensed to be “0”, and the sense signal that implies the touch is not sensed to be “1”.

4. The touch sensing apparatus of claim 1, wherein the sense unit comprises:
a reference capacitor having a first end connected to the one sense scan line and a second end connected to the sense line;
a variable capacitor having a first end connected to the sense line and a second end connected to a common electrode; and
a liquid crystal layer between the first and second ends of the variable capacitor.

5. The touch sensing apparatus of claim 4, wherein the sense unit senses touch in a row direction or senses touch in a column direction.

6. The touch sensing apparatus of claim 1, wherein the logic operation circuit is a NAND circuit.

7. The touch sensing apparatus of claim 1, further comprising switches respectively connected to the plurality of sense scan lines to apply predetermined voltages thereto.

8. The touch sensing apparatus of claim 7, further comprising a sense driver that applies the sense driving signal of a gate-on voltage for turning on the switches and a gate-off voltage for turning off the switches to gate electrodes of the switches.

9. The touch sensing apparatus of claim 1, further comprising an amplification unit connected to the sense line to amplify and filter the sense signal.

10. The touch sensing apparatus of claim 1, further comprising a latch unit which extracts and maintains a sample of the sense signal.

11. A display device comprising:
a display panel having a plurality of pixels that display an image and a plurality of sense units, each sense unit to being capable of generating a corresponding sense signal, and the plurality of pixels and the plurality sense units being arranged in a matrix format;
a location detection unit that detects a location of a touch on the display panel from the generated sense signal on receipt of a trigger signal indicating that the location detection unit is to operate and does not detect the location on receipt of a trigger signal indicating that the location detection unit is to not operate; and
a determination and trigger unit that determines whether the touch is sensed from the sense signal, generates the trigger signal to instruct whether or not to operate the location detection unit, and transmits the trigger signal to the location detection unit,
wherein the determination and trigger unit generates the trigger signal for operation of the location detection unit when at least one sense signal transmitted to one row-direction sense unit or one column-directional sense unit implies that the touch is sensed.

12. The display device of claim 11, wherein the determination and trigger unit comprises a NAND circuit which generates the trigger signal, and determines a sense signal implying that the touch is sensed to be “0” and a sense signal implying that the touch is not sensed to be “1”.

13. The display device of claim 11, further comprising a plurality of switches respectively connected to a plurality of sense scan lines that are connected to the plurality of sense units and transmit predetermined voltages.

14. The display device of claim 13, further comprising a sense driver that applies a sense driving signal including a gate-on voltage that turns on the switches and a gate-off voltage that turns off the switches to gate electrodes of the switches.

15. The display device of claim 11, further comprising an amplification unit that amplifies and filters the generated sense signal.

16. The display device of claim 11, further comprising a latch unit that extracts and maintains a sample of the sense signal.

17. A driving method of a display device including a display panel having a plurality of pixels displaying an image and a plurality of sense units, each sense unit being capable of generating a corresponding sense signal, the pixels and the sense units being arranged in a matrix format, a location detection unit determining a location of touch from the sense signal, and a determination and trigger unit instructing whether or not to operate the location detection unit from the sense signal, the driving method comprising:
generating the sense signal by applying a predetermined voltage to one row-direction sense unit or one column-directional sense unit among the plurality of sense units;
generating a first trigger signal that instructs the location detection unit to operate when the generated sense signal implies that the touch is sensed; and
determining a location of a touch from the sense signal according to the generated first trigger signal.

18. The driving method of claim 17, wherein the generating the sense signal comprises generating the sense signal for each of the plurality of sense units by applying the predetermined voltage to each of the sense units, and the method further comprises:
generating a second trigger signal instructing the location detection unit to stop operation when all the sense signals imply that the touch is not sensed; and
ignoring the sense signal according to the second trigger signal.

19. The driving method of claim 17, further comprising amplifying and filtering the generated sense signal.

20. The driving method of claim 19, further comprising extracting and maintaining a sample of the amplified sense signal.
